(19) United States
(12) Patent Application Publication
(10) Pub. No.: US 2026/0156369 A1
(43) Pub. Date: Jun. 4, 2026

(54) IMPLEMENTATION METHOD FOR HIGH-DYNAMIC-RANGE IMAGE SENSOR

(71) Applicant: GALAXYCORE SHANGHAI LIMITED CORPORATION, Shanghai (CN)

(72) Inventors: Ming KANG, Shanghai (CN); Kai ZHAO, Shanghai (CN)

(73) Assignee: GALAXYCORE SHANGHAI LIMITED CORPORATION, Shanghai (CN)

(21) Appl. No.: 19/122,311

(22) PCT Filed: Jul. 20, 2023
(86) PCT No.: PCT/CN2023/108306

§ 371 Date: Apr. 18, 2025

(30) Foreign Application Priority Data
Oct. 27, 2022 (CN) 202211327591.4

(51) Int. Cl. H04N 23/76; G06T 5/92

(52) U.S. Cl. CPC H04N 23/76; G06T 5/92

(57) ABSTRACT

An implementation method for a high-dynamic-range image sensor is provided. A luminance component in a nonlinear image signal obtained by a nonlinear analog-to-digital conversion circuit is compressed to output an HDR image signal, thereby reducing a data transmission amount and improving a transmission frame rate. The number of bits of the HDR image signal may be the same as the number of bits of the image signal output by the image sensor using the linear analog-to-digital conversion circuit, thereby realizing high-speed and high-precision acquisition of the HDR image signal. By performing nonlinear compression on an extracted high-bit luminance signal, image details are retained as much as possible, and a high-quality image signal is output.

### CROSS-REFERENCE TO RELATED APPLICATIONS

The present disclosure is a National Stage of International Application No. PCT/CN2023/108306 filed on Jul. 20, 2023, which claims priority to Chinese Patent Application No. 202211327591.4, filed on Oct. 27, 2022, and entitled “IMPLEMENTATION METHOD FOR HIGH-DYNAMIC-RANGE IMAGE SENSOR”, the entire disclosure of which is incorporated herein by reference.

### TECHNICAL FIELD

The present disclosure generally relates to an implementation method for a High-Dynamic-Range (HDR) image sensor.

### BACKGROUND

An image sensor is a device that converts optical images into electronic signals, which has been widely applied in digital cameras, camera phones, digital video cameras, medical cameras (such as gastroscopes), automotive cameras, etc.

After acquiring an image, the image sensor outputs the image to a processing platform through an interface circuit. With the development of integrated circuits and the increment of user requirements on image quality, high-pixel image sensors have been provided to achieve high-precision image acquisition, and HDR image signals can be acquired through technologies such as nonlinear Analog-to-Digital Converter (ADC). However, these high-precision or HDR image signal data is relatively huge, usually being 10-bits or even 11-bits or more high-bit signals. A traditional method for outputting a high-bit image without any post-processing is illustrated in FIG. 1. The image sensor directly outputs an acquired high-bit image signal to a processing platform.

### SUMMARY

Embodiments of the present disclosure provide an implementation method for an HDR image sensor, which realizes outputting high-quality image signals under the premise of improving a transmission frame rate of the image sensor, thereby meeting application requirements of different application scenarios.

An embodiment of the present disclosure provides an implementation method for an HDR image sensor, including: performing analog-to-digital conversion on an image signal by using a nonlinear analog-to-digital conversion circuit to obtain a nonlinear image signal; and compressing a luminance component in the nonlinear image signal to output an HDR image signal.

Preferably, a number of bits of the output HDR image signal is the same as a number of bits of an image signal output by an image sensor using a linear analog-to-digital conversion circuit.

Preferably, said compressing the luminance component in the nonlinear image signal to output the HDR image signal includes: linearizing the nonlinear image signal to obtain a linear high-bit image signal; separating a chrominance component and a luminance component of the linear high-bit image signal; compressing the luminance component, and remaining the chrominance component unchanged, to output an HDR low-bit image signal.

Preferably, said separating the chrominance component and the luminance component of the linear high-bit image signal includes: characterizing image luminance using a weighted mean or a maximum value to extract a high-bit luminance signal.

Preferably, said compressing the luminance component includes: performing nonlinear compression on the high-bit luminance signal to obtain a low-bit luminance signal.

Preferably, said performing nonlinear compression on the high-bit luminance signal to obtain the low-bit luminance signal includes: dynamically adjusting a nonlinear compression curve to obtain a corresponding relationship between the high-bit luminance signal and the low-bit luminance signal.

Preferably, said dynamically adjusting the nonlinear compression curve includes: determining a detail region of interest based on a histogram or an artificial intelligence method; in response to luminance of the detail region being low, using the nonlinear compression curve with a larger slope in a front section; and in response to the luminance of the detail region being high, using the nonlinear compression curve with a larger slope in a back section.

Preferably, said performing nonlinear compression on the high-bit luminance signal to obtain the low-bit luminance signal includes: using a fixed nonlinear compression curve to obtain a corresponding relationship between the high-bit luminance signal and the low-bit luminance signal.

Preferably, said performing nonlinear compression on the high-bit luminance signal to obtain the low-bit luminance signal includes: obtaining a corresponding relationship between the high-bit luminance signal and a gain value based on a nonlinear compression curve.

Preferably, said remaining the chrominance component unchanged includes: the low-bit image signal=the high-bit image signal×gain value.

Preferably, prior to said separating the chrominance component and the luminance component of the linear high-bit image signal, the method further includes: performing anti-bad pixel diffusion preprocessing on the linear high-bit image signal by filtering.

Compared with the existing techniques, in the implementation method for the HDR image sensor provided in the embodiments of the present disclosure, the luminance component in the nonlinear image signal obtained by the nonlinear analog-to-digital conversion circuit is compressed to output the HDR image signal, thereby reducing a data transmission amount and improving a transmission frame rate. The number of bits of the HDR image signal may be the same as the number of bits of the image signal output by the image sensor using the linear analog-to-digital conversion circuit, thereby realizing high-speed and high-precision acquisition of the HDR image signal. By performing nonlinear compression on the extracted high-bit luminance signal, image details are retained as much as possible, and a high-quality image signal is output. Further preferably, the detail region of interest may be determined based on a histogram or an artificial intelligence method. In response to luminance of the detail region being low, the nonlinear compression curve with a larger slope in a front section is used; or in response to the luminance of the detail region being high, the nonlinear compression curve with a larger slope in a back section is used. By dynamically adjusting the nonlinear compression curve, application requirements of different application scenarios can be met.

### BRIEF DESCRIPTION OF THE DRAWINGS

Other features, objects and advantages of the present disclosure will become more clear from following detailed description of non-limiting embodiments with reference to accompanying drawings.

FIG. 1 is a schematic diagram of an image output method of an image sensor in existing techniques;

FIG. 2 is a schematic diagram of an image output method of an image sensor according to an embodiment of the present disclosure;

FIG. 3 is a flow chart of an image output method of an image sensor according to an embodiment of the present disclosure;

FIG. 4 is a schematic diagram of a nonlinear compression curve of an image sensor according to an embodiment of the present disclosure;

FIG. 5 is a schematic diagram of a gain curve of an image sensor according to an embodiment of the present disclosure; and

FIG. 6(A) and FIG. 6(B) are schematic diagrams of filtering preprocessing of an image sensor according to an embodiment of the present disclosure.

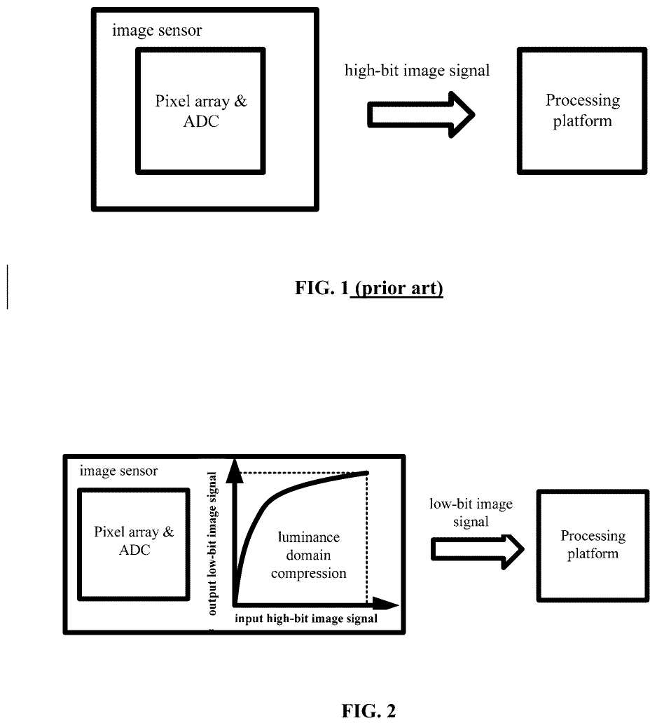

In the drawings, the same or similar reference numerals denote the same or similar devices (modules) or steps throughout different drawings.

### DETAILED DESCRIPTION

To solve the problems in the existing techniques, embodiments of the present disclosure provide an implementation method for an HDR image sensor, including: performing analog-to-digital conversion on an image signal by using a nonlinear analog-to-digital conversion circuit to obtain a nonlinear image signal; and compressing a luminance component in the nonlinear image signal to output an HDR image signal, which reduces a data transmission amount and improves a transmission frame rate.

In following specific description of preferred embodiments, reference will be made to accompanying drawings which constitute a part of the present disclosure. The accompanying drawings show by way of example specific embodiments that can implement the present disclosure. The illustrative embodiments are not intended to be exhaustive in enumerating all embodiments of the present disclosure. It could be understood that other embodiments may be utilized, and structural or logical modifications may also be made without departing from the scope of the present disclosure. Therefore, the following specific description is not restrictive, and the scope of the present disclosure is limited by appended claims.

As illustrated in FIG. 2, an embodiment of the present disclosure provides an implementation method for an HDR image sensor, including: performing analog-to-digital conversion on an image signal by using a nonlinear analog-to-digital conversion circuit to obtain a nonlinear image signal; and compressing a luminance component in the nonlinear image signal to output an HDR image signal to a processing flatform. For example, the nonlinear image signal after the conversion is an N-bit signal, and the output HDR image signal is at most an (N−1)-bit signal, thereby reducing a data transmission amount, improving a transmission frame rate, and realizing output of high-quality image signals under the premise of the relatively high transmission frame rate. Preferably, the number of bits of the output HDR image signal may be the same as the number of bits of the image signal output by the image sensor using the linear analog-to-digital conversion circuit. For example, for a conventional linear ADC, a 10-bit image signal can be acquired within a time period of T, a 12-bit image signal can be acquired within a time period of 4T, and a 13-bit image signal can be acquired within a time period of 8T, while the nonlinear ADC can acquire a 10-bit nonlinear image signal within the time period of T, and perform linearization processing on the 10-bit nonlinear image signal to obtain a 13-bit image signal, thereby realizing high-speed and high-precision acquisition of HDR image signals. Especially for high-bit image signals with N greater than or equal to 11, the method of the present disclosure is of great significance, and can significantly increase the transmission frame rate and improve performance of the image sensor.

Specifically, the image sensor includes a pixel array which may be a Bayer array or a 4-in-1, 9-in-1, or 16-in-1 multi-unit array. An image signal is acquired by pixel units of the pixel array, the image signal is converted from analog to digital using a nonlinear analog-to-digital conversion circuit to obtain a nonlinear image signal, the nonlinear image signal is linearized to obtain a linear high-bit image signal, a chrominance component and a luminance component of the linear high-bit image signal are separated, the luminance component is compressed, and the chrominance component remains unchanged, to output an HDR low-bit image signal, thereby reducing the data transmission amount and improving the transmission frame rate.

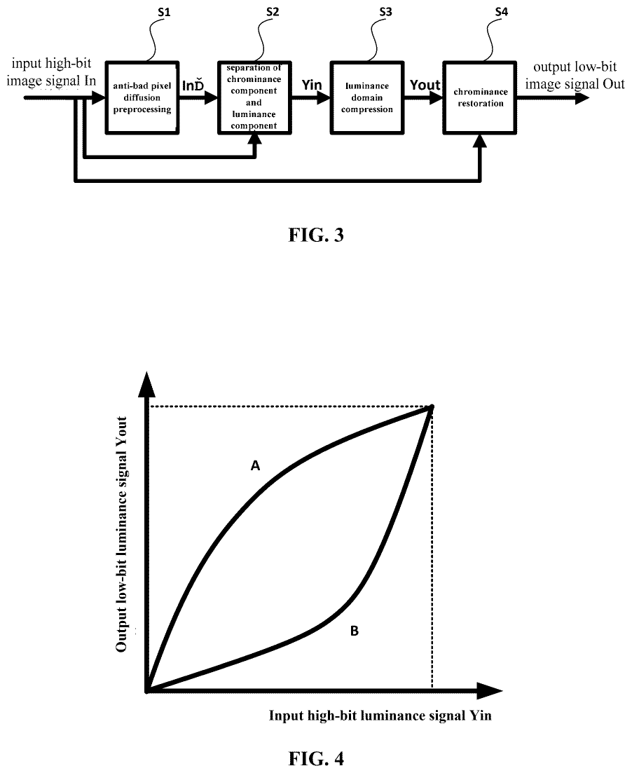

FIG. 3 is a flow chart of an implementation method for an HDR image sensor according to an embodiment of the present disclosure. The method includes S1 to D4.

In S1, anti-bad pixel diffusion preprocessing is performed.

As bad pixels are common in image sensors, it is preferred to use filtering to perform anti-bad pixel diffusion preprocessing on the high-bit image signal output by each pixel unit prior to separating the chrominance component and the luminance component, to further improve image quality. The preprocessing can be expressed by a following formula,

$${In}^{′} = {Filter}_{m * n} ( In ) ,$$

wherein Filter_{m*n} refers to a filter with height of m and width of n, which may be a mean filter, a median filter, a second maximum filter or a Gaussian filter, a size of the filter can vary according to an actual application scenario, In is the high-bit image signal output by the pixel unit, and In′ is the high-bit image signal after the preprocessing.

In S2, a chrominance component and a luminance component are separated.

Separation of the chrominance component and the luminance component is performed on the high-bit image signal In′ after the preprocessing. Preferably, image luminance is characterized by using a weighted mean or a maximum value (but not limited to the two methods, other luminance representation methods in the art can also be used to implement the present disclosure) to extract a high-bit luminance signal. A formula for luminance extraction is as follows,

$$Yin = \frac{( {k}_{1} * R + {k}_{2} * G + {k}_{3} * B )}{( {k}_{1} + {k}_{2} + {k}_{3} )} or$$

$$Yin = max ( R , G , B ) .$$

Alternatively, those skilled in the art may omit the anti-bad pixel diffusion preprocessing step as needed, and directly select an appropriate formula for luminance extraction for the high-bit image signal In output by the pixel unit to perform luminance extraction, which is not repeated here.

After extracting the luminance Yin, the chrominance extraction is performed. A formula for chrominance extraction is as follows,

$${C}_{ratio} = \frac{In}{{Y}_{in}} ,$$

where Cratio is image chrominance information, and Yin is the extracted high-bit luminance signal.

In S3, the luminance component is compressed.

The high-bit luminance signal Yin may be compressed by linear compression or nonlinear compression to obtain a low-bit luminance signal Yout.

However, linear compression, also known as truncation compression, may result in a loss of some signal details (such as truncation in dark regions and truncation in bright regions), thus, compression effect is not ideal. Therefore, it is preferred to use nonlinear compression to compress the high-bit luminance signal Yin to obtain the low-bit luminance signal Yout.

FIG. 4 is a schematic diagram of a nonlinear compression curve. Those skilled in the art may choose to use a fixed nonlinear compression curve or a dynamically adjusted nonlinear compression curve according to actual needs to obtain a corresponding relationship between the input high-bit luminance signal Yin and the output low-bit luminance signal Yout.

Specifically, dynamically adjusting the nonlinear compression curve means performing less compression on more critical regions (such as faces and flowers) that a user concerns and is more interested in, and performing more compression on other non-critical regions. Preferably, a detail region concerned is determined based on a histogram or an artificial intelligence method. If luminance of the detail region is relatively low, the nonlinear compression curve with a larger slope in a front section is adopted (such as a curve A in FIG. 4). If the luminance of the detail region is relatively high, the nonlinear compression curve with a larger slope in a back section is adopted (such as a curve B in FIG. 4). In this manner, application requirements of different application scenarios can be flexibly met.

Further, as illustrated in FIG. 5, a corresponding relationship between the input high-bit luminance signal Yin and a gain value Gain may be obtained based on the nonlinear compression curve, so as to simplify a subsequent chrominance restoration step.

In S4, chrominance restoration is performed.

Generally, the chrominance restoration may be performed based on a following formula,

$$Out = {C}_{ratio} * {Y}_{out} ,$$

where Out is the low-bit image signal finally output, and Yout is the low-bit luminance signal output after nonlinear compression.

As the formula for chrominance extraction contains division, a divider is required when designing a chip. To avoid a large overhead caused by the divider, the formula for the chrominance extraction and the chrominance restoration may be simplified to obtain a following formula,

$$Out = \frac{{Y}_{out}}{Yin} * In = Gain * In .$$

That is, it is preferred to perform the chrominance restoration by simplifying the formulas, so as to obtain the output low-bit image signal=the input high-bit image signal×the gain value.

The implementation method for the HDR image sensor provided in the present disclosure is described in detail below with reference to a specific embodiment.

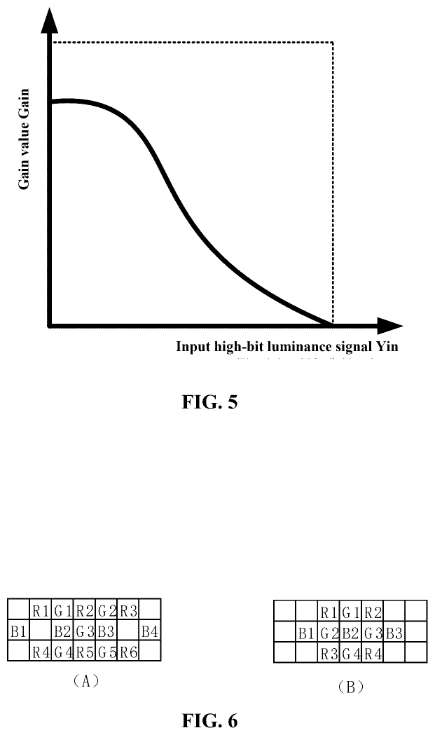

First, anti-bad pixel diffusion preprocessing is performed on the high-bit image signal In output by each pixel unit of the image sensor in the embodiment by using median filtering to obtain the high-bit image signal In′ after filtering preprocessing. In the embodiment, a maximum filtering window is 3×7. FIG. 6 includes schematic diagrams of a filter size in a RAW domain, where FIG. 6(A) is a schematic diagram with a center point G, and FIG. 6(B) is a schematic diagram with a center point B (those skilled in the art can understand that a case of center point R is similar).

When the center point is G, RGB filter value ranges are as following,

$$R = Medium ( {R}_{1} , {R}_{2} , {R}_{3} , {R}_{4} , {R}_{5} , {R}_{6} )$$

$$G = Medium ( {G}_{1} , {G}_{2} , {G}_{3} , {G}_{4} , {G}_{5} )$$

$$B = Medium ( {B}_{1} , {B}_{2} , {B}_{3} , {B}_{4} ) .$$

When the center point is B (similar to R), the RGB filter value ranges are as following,

$$R = Medium ( {R}_{1} , {R}_{2} , {R}_{3} , {R}_{4} , )$$

$$G = Medium ( {G}_{1} , {G}_{2} , {G}_{3} , {G}_{4} )$$

$$B = Medium ( {B}_{1} , {B}_{2} , {B}_{3} ) .$$

A ratio R:G:B=1:2:1 is adopted for luminance extraction. This ratio can not only better represent the image luminance, but also allow a hardware circuit to simply implement calculations through shifting, which enables to extract the high-bit luminance signal Yin with low overhead.

$$Yin = \frac{( R + 2 * G + B )}{4} .$$

In some embodiments, a portrait shooting mode is adopted, and the detail region the user concerns is determined to be a face region through the histogram or the artificial intelligence method. To preserve details of the face region with relatively low luminance, as illustrated by the curve A in FIG. 4, a nonlinear compression curve with a large slope in a first half of section is used as the compression curve, and the corresponding gain curve is illustrated in FIG. 5, thereby obtaining the corresponding relationship between the input high-bit luminance signal Yin and the output low-bit luminance signal Yout, as well as the corresponding relationship between the input high-bit luminance signal Yin and the gain value Gain.

Finally, chrominance restoration is performed based on a formula Out=Gain*In, to obtain a low-bit image signal Out to be output to the processing platform, thereby achieving output of high-quality image signals under the premise of improving the transmission frame rate of the image sensor to meet application requirements of different application scenarios.

In summary, in the implementation method for the HDR image sensor provided in the embodiments of the present disclosure, the luminance component in the nonlinear image signal obtained by the nonlinear analog-to-digital conversion circuit is compressed to output the HDR image signal, thereby reducing a data transmission amount and improving a transmission frame rate. The number of bits of the HDR image signal may be the same as the number of bits of the image signal output by the image sensor using the linear analog-to-digital conversion circuit, thereby realizing high-speed and high-precision acquisition of the HDR image signal. By performing nonlinear compression on the extracted high-bit luminance signal, image details are retained as much as possible, and a high-quality image signal is output. Further preferably, the detail region of interest may be determined based on a histogram or an artificial intelligence method. In response to luminance of the detail region being low, the nonlinear compression curve with a larger slope in a front section is used; or in response to the luminance of the detail region being high, the nonlinear compression curve with a larger slope in a back section is used. By dynamically adjusting the nonlinear compression curve, application requirements of different application scenarios can be met.

It is clear to those skilled in the art that the present disclosure is not limited to the details of the exemplary embodiments described above, and that the present disclosure can be implemented in other specific forms without departing from the spirit or essential features of the present disclosure. Therefore, in any case, the embodiments should be regarded as exemplary and non-restrictive. In addition, it is clear that the word “including” does not exclude other elements and steps, and the wording “a” does not exclude the plural. Multiple elements stated in the device claim may also be implemented by one element. The words first, second, etc. are used to indicate names, and do not indicate any particular order.

What is claimed is:

1. An implementation method for a High-Dynamic-Range (HDR) image sensor, comprising:
performing analog-to-digital conversion on an image signal to obtain a nonlinear image signal by using a nonlinear analog-to-digital conversion circuit; and
compressing a luminance component in the nonlinear image signal to output an HDR image signal.

2. The method according to claim 1, wherein a number of bits of the output HDR image signal is the same as a number of bits of an image signal output by an image sensor using a linear analog-to-digital conversion circuit.

3. The method according to claim 1, wherein said compressing the luminance component in the nonlinear image signal to output the HDR image signal comprises:
linearizing the nonlinear image signal to obtain a linear high-bit image signal;
separating a chrominance component and a luminance component of the linear high-bit image signal; and
compressing the luminance component, and remaining the chrominance component unchanged, to output an HDR low-bit image signal.

4. The method according to claim 3, wherein said separating the chrominance component and the luminance component of the linear high-bit image signal comprises:
characterizing image luminance using a weighted mean or a maximum value to extract a high-bit luminance signal.

5. The method according to claim 4, wherein said compressing the luminance component comprises:
performing nonlinear compression on the high-bit luminance signal to obtain a low-bit luminance signal.

6. The method according to claim 5, wherein said performing nonlinear compression on the high-bit luminance signal to obtain the low-bit luminance signal comprises:
dynamically adjusting a nonlinear compression curve to obtain a corresponding relationship between the high-bit luminance signal and the low-bit luminance signal.

7. The method according to claim 6, wherein said dynamically adjusting the nonlinear compression curve comprises:
determining a detail region of interest based on a histogram or an artificial intelligence method;
in response to luminance of the detail region being low, using the nonlinear compression curve with a larger slope in a front section; and
in response to the luminance of the detail region being high, using the nonlinear compression curve with a larger slope in a back section.

8. The method according to claim 5, wherein said performing nonlinear compression on the high-bit luminance signal to obtain the low-bit luminance signal comprises:
using a fixed nonlinear compression curve to obtain a corresponding relationship between the high-bit luminance signal and the low-bit luminance signal.

9. The method according to claim 5, wherein said performing nonlinear compression on the high-bit luminance signal to obtain the low-bit luminance signal comprises:
obtaining a corresponding relationship between the high-bit luminance signal and a gain value based on a nonlinear compression curve.

10. The method according to claim 9, wherein said remaining the chrominance component unchanged comprises:
the low-bit image signal=the high-bit image signal×gain value.

11. The method according to claim 3, wherein prior to said separating the chrominance component and the luminance component of the linear high-bit image signal, the method further comprises:
performing anti-bad pixel diffusion preprocessing on the linear high-bit image signal by filtering.
